(19) United States
(12) Patent Application Publication
(10) Pub. No.: US 2005/0109133 A1
(43) Pub. Date: May 26, 2005

(54) Adaptor means

(76) Inventor: John Lamb, Keighley (GB)

Correspondence Address: Michael E. Sellers;Gable & Gotwals, 10th Floor, 100 W. 5th Street, Tulsa, OK, 74103, US

(21) Appl. No.: 10/987,253

(22) Filed: Nov. 12, 2004

(30) Foreign Application Priority Data
Nov. 13, 2003 (GB) 0326403.3

(51) Int. Cl. G01N 7/00

(52) U.S. Cl. 73/866.5

(57) ABSTRACT

Adaptor means are provided for use with gas measuring apparatus. The adaptor means is in the form of a tee-piece adaptor having a body portion with a channel defined therethrough. The body portion includes inlet means for allowing the flow of gas from gas supply means into the channel, first outlet means for allowing gas in the channel to exit the channel and second outlet means located between the inlet means and the first outlet means. The second outlet means communicates with the channel and allows connection with gas sensing and/or measuring means. At least a part of the inlet means tapers inwardly towards the channel.

### 1. REFERENCE TO PRIOR APPLICATION(S)

This application claims priority to Great Britain Patent Application No. 0326403.3 filed Nov. 13, 2003.

### 2. FIELD OF THE INVENTION

The present invention relates generally to adaptor means for use with gas measuring apparatus.

### 3. BACKGROUND OF THE INVENTION

In mixed gas diving, such as scuba diving, the depth at which the diver descends to, the length of time the diver spends on the sea floor and the number and length of time of decompression stops are all calculated and controlled based on the partial pressure of oxygen available to the diver during the dive. As such, it is important for the amount of oxygen available in a diver's oxygen tank to be accurately measured and monitored throughout the dive. An inaccuracy in this measurement in excess of 1% can result in the start of an incident pit (a series of problems which can result in a major incident) which may prove fatal to the diver. It is therefore essential that the diver can accurately, quickly and easily measure the oxygen concentration in a sub-aqua diving cylinder prior to diving.

A problem associated with conventional gas measuring apparatus is that the gas flowing from the gas cylinder is under pressure and the flow rate of the gas is high when it reaches the gas analyser for measuring the percentage of gas contained in the gas cylinder. This can cause a back pressure to build up on the sensor and, since most sensors are partial pressure measuring devices, this back pressure build up increases the reading and provides an inaccurate measurement of the gas contained in the gas cylinder.

In order to try and reduce the pressure of the gas flowing onto the gas sensor, it is known to provide adaptors in connection with the sensor, such as Tee piece adaptors. A conventional Tee piece adaptor 1 typically has a body 2 with a T-shaped channel running therethrough, as shown in FIG. 1. A cylindrical inlet port 4 of adaptor 1 is connected to an oxygen source, such as an oxygen tank 8, via a sealing connection 10. The sealing connection 10 could be a flowrate controller, such as a flowmeter or a fixed hole orifice provided in a restrictor. An outlet port 11 of the adaptor is open to atmosphere via conduit 12. Gas measuring apparatus in the form of an oxygen sensor 14 is connected to a diverter portion 15 of adaptor 1. The oxygen sensor 14 is connected to an oxygen analyser 18 via cable 19 and analyser 18 has a display screen 20 for displaying the measured percentage oxygen content of the cylinder 8. A control valve 22 is provided on the cylinder to control the level of oxygen flowing therefrom. The adaptor 1, and oxygen sensor 14 can form part of analyser 18 if required.

In FIG. 1, the gas cylinder is opened three times, each for a short period of time. This leaves a sample of stationary gas on the sensor 14. Since conduit 12 opens to atmosphere, the gas sample at the sensor is at 1 Bar. The conduit 12 slows down the ingress of atmospheric air which could dilute the gas being sampled at the sensor.

The oxygen sensor 14, such as for example a Teledyne R-17 Sensor, provides a sensor face in the form of a pressure membrane adjacent the end 16 of diverter portion 15. The diverter portion 15 allows the flow of gas from the cylinder 8 to be turbulent and diverts the gas rapidly onto the pressure membrane and out of the adaptor. Two one way valves are provided in the adaptor adjacent the inlet and outlet ports 4, 11, either side of the diverter portion 15. These one way valves allow the gas pressure to rise in the area surrounding the pressure membrane on opening of the gas cylinder valve to allow gas flow into the adaptor. Once the gas reading becomes stabilised, this reading represents the quantity of gas contained in the gas cylinder. Thus, the adaptor is provided to reduce the flow of gas from the cylinder to provide a more accurate reading. However, there are still problems associated with the flow rate of the gas being too high when flowing across the sensor, thereby resulting in damage to the sensor.

Further known prior art adaptors are illustrated in FIGS. 3a-3c. In FIG. 3a, the sensor is inside the analyser 18. The adaptor 26 has a substantially planar end 28 which has screw threads provided adjacent the same for attachment to corresponding screw threads on sensor 24. Gas from a cylinder flows through a small aperture 30 of adaptor 26 and onto sensor face 24. The gas escapes via aperture 32 into the atmosphere.

In FIG. 3b, the sensor is inside the analyser 18 and the gas is fed from cylinder 33 via a flow meter 34 into an adaptor 36 in the form of a conventional tee-piece. Alternatively, a flow restrictor 38 can be used in place of the flow meter 34, as shown in FIG. 3c. The flow restrictor or flow meter reduces the flow of gas to the sensor to about two Litres per minute, thereby helping to prevent damage to the sensor caused by high gas flow rates.

Further problems associated with known gas measuring apparatus are that the temperature of the gas flowing from the gas cylinder is cold, whilst the gas sensor is typically at ambient temperature. As such, the sensor begins to cool down during gas measurement and can cause inaccuracies in the quantity of gas measured in the gas cylinder. For example, the readings can change by up to 2.5% per degree Celsius change in temperature of the sensor. In order to overcome this problem, temperature compensation equipment is required and is located at the rear of the sensor. This temperature compensation equipment increases the cost and complexity of manufacturing the device which is undesirable. In addition, any poor joints/connections formed between the cylinder connection and the adaptor, particularly in the prior art adaptor illustrated in FIG. 3a, results in a Venturi action with atmospheric air being sucked into the apparatus, thereby also providing inaccurate gas readings. In the prior art adaptor illustrated in FIG. 3b, a continuous flow of gas is provided across the sensor with gas adjacent the sensor face being continuously replaced with cold gas from the cylinder, thereby confusing the temperature compensation equipment and providing inadequate temperature compensation.

It is therefore an object of the present invention to provide adaptor means which can be used with gas measuring apparatus to provide accurate gas measurements to be taken both quickly and easily.

It is a further object of the present invention to provide an adaptor portion for use with adaptor means.

It is a yet further object of the present invention to provide gas measuring apparatus including adaptor means.

### BRIEF SUMMARY OF THE INVENTION

According to a first aspect of the present invention there is provided adaptor means for use with gas measuring apparatus, said adaptor means in the form of a tee-piece adaptor having a body portion with a channel defined therethrough, said body portion including inlet means for allowing the flow of gas from gas supply means into the channel, first outlet means for allowing gas in the channel to exit the channel and second outlet means located between said inlet means and said first outlet means, said second outlet means communicating with said channel and allowing connection with gas sensing and/or measuring means, and wherein at least a part of said inlet means tapers inwardly towards said channel.

The advantage of the inwardly tapering part is that it reduces the venturi effect associated with prior art devices. More specifically, at least a part of the walls defining the inlet means or inlet part have an inwardly narrowing taper.

Preferably the inwardly tapering part of the inlet means is substantially concave in shape. At least one inlet aperture is typically provided between the concave means or port and the channel in the adaptor means.

In an alternative embodiment the inwardly tapering part of the inlet port is substantially conical in shape.

Preferably the second outlet means is provided on an arm portion which protrudes outwardly from the body portion. A channel defined in the arm portion communicates with the channel defined in the body portion. The second outlet means is provided on the arm portion in communication with the channel defined in said arm portion.

Preferably the arm portion and/or channel defined therein is provided substantially perpendicular to the body portion and/or channel portion defined therein.

Further preferably the second outlet means is provided at an end of the arm portion.

Diverting means are associated with the second outlet means for diverting the flow of gas as it flows from the inlet means to the first outlet means. The diverting means has one or more members which protrude into the channel of the body portion passing between the inlet means and the first outlet means. These members allow a small sample of gas to be diverted towards the gas measuring/sensing apparatus without directing the entire flow of gas towards the sensing/measuring apparatus. As such, damage to the sensor is prevented or significantly reduced compared to prior art devices which allow the flow of gas from the cylinder directly onto the sensor face of the sensing equipment.

The arm portion in which the second outlet means is defined is typically reduced in length compared to that of a conventional tee-piece to allow the diverting means to be positioned such that at least a portion thereof protrudes sufficiently well into the main channel of the body portion between the inlet means and the first outlet means to allow a sample of the gas flowing therebetween to be diverted.

Sealing means can be provided on the diverting means to prevent a venturi effect as a result of leaks via the connection of the diverting means with the adaptor means. Thus the sealing means are typically provided between the engaging surfaces of the diverting means and/or the arm portion, second outlet means and/or adaptor means.

In a preferred embodiment the diverting means has members in a cruxiform arrangement.

The diverting means can be in the form of a flow divert valve which is attached to the free end of the second outlet means.

The flow divert valve or diverting means is typically provided with engagement means thereon for allowing engagement of a part thereof with gas sensing and/or measuring apparatus. Alternatively the diverting means is integrally formed with the second outlet means, arm portions and/or adaptor means.

Preferably the body portion is provided in at least two parts, said parts detachably attached together via attachment means. The attachment means can include any or any combination of conventional attachment means, such as adhesive, screws, clip, protrusions and/or recesses and/or the like. In a preferred embodiment the parts of the adaptor means are detachably attached via a friction fit.

In one embodiment the first part or inlet portion of the adaptor means preferably includes the inlet means, and the second part of the adaption means preferably includes the first and second outlet means.

The inlet portion of the adaptor means can be retrofitted to a conventional tee-piece adaptor if required.

Preferably the gas sensing and/or measuring means connected to the adaptor means has a measuring resolution of +/−0.1%.

Preferably the exterior surface of the body portion in which the inlet means is defined is substantially dome shaped. The inlet means or port is typically provided in said dome shaped wall. The dome shaped walls increases the ease with which the same can be engaged with gas supply means.

Preferably one or more one way valves, and further preferably two one way valves are provided in the adaptor means.

These valves are preferably associated with channels defined in the body portion of the adaptor means. The valves are typically provided either side of the second outlet means in the main channel passing between the inlet means and the first outlet means, thereby preventing dilution of the gas being sampled by the diverting means.

According to a second aspect of the present invention there is provided an inlet portion for attachment to adaptor means. Thus the assembled adaptor means includes first and second parts joined together.

According to a further aspect of the present invention there is provided gas measuring apparatus including adaptor means and/or an inlet portion for attachment to adaptor means.

The adaptor means of the present invention can be used with any conventional gas measuring apparatus and can be used to measure any or any combination of gases, such as Nitrox, oxygen and/or the like. The advantage of the present invention is that it does not rely on a user controlling an accurate flow rate (i.e. the user is not required to take the gas measurement at 1 Bar pressure or a fixed flow rate as is required with conventional apparatus).

Although diverting means are known with gas measuring equipment, it is not known to use diverting means with a tee-piece adaptor having one way valves provided therein. Tee-pieces having one way valves therein are known in the medical field but the second outlet means are normally provided for location in a user's mouth and thus diverting means would not normally be used with such devices.

### BRIEF DESCRIPTION OF THE DRAWINGS

An embodiment of the present invention will now be described with reference to the accompanying figures, wherein:

FIG. 1 illustrates conventional gas measuring apparatus;

FIG. 2a is a side view of adaptor means according to an embodiment of the present invention;

FIG. 2b is a bottom view of the adaptor means without the inlet portion in FIG. 2a;

FIG. 2c is a cross sectional view taken through the adaptor means in FIG. 2a;

FIG. 2d is a side view of the inlet portion shown in FIG. 2a;

FIGS. 3a and 3b illustrate conventional gas measuring apparatus;

FIGS. 4a-4c illustrate a perspective view, a view from above and a view from below respectively of diverting means according to an embodiment of the present invention; and

FIG. 4d illustrates diverting means in place in the adaptor means illustrated in FIG. 2a.

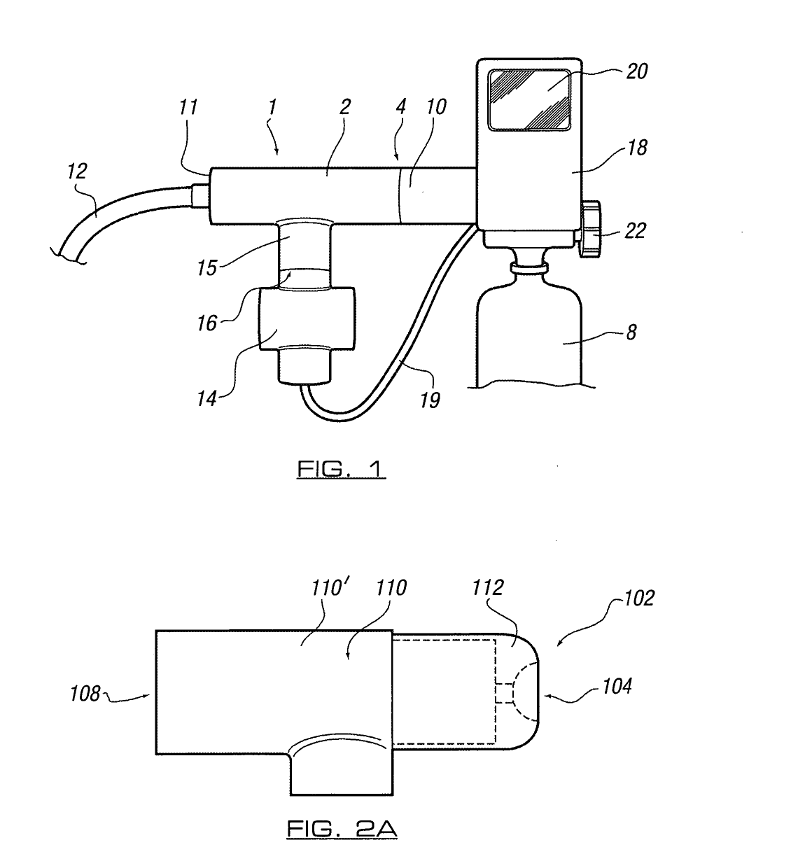

### DETAILED DESCRIPTION OF THE PREFERRED EMBODIMENT(S)

Although the following description refers almost exclusively to adaptor means for use with oxygen measuring apparatus for measuring the amount of oxygen available in a diver's oxygen tank, it will be appreciated by persons skilled in the art that the present invention could be used in conjunction with or as part of any gas measuring apparatus for measuring the amount of any required gas in any container, cylinder or receptacle.

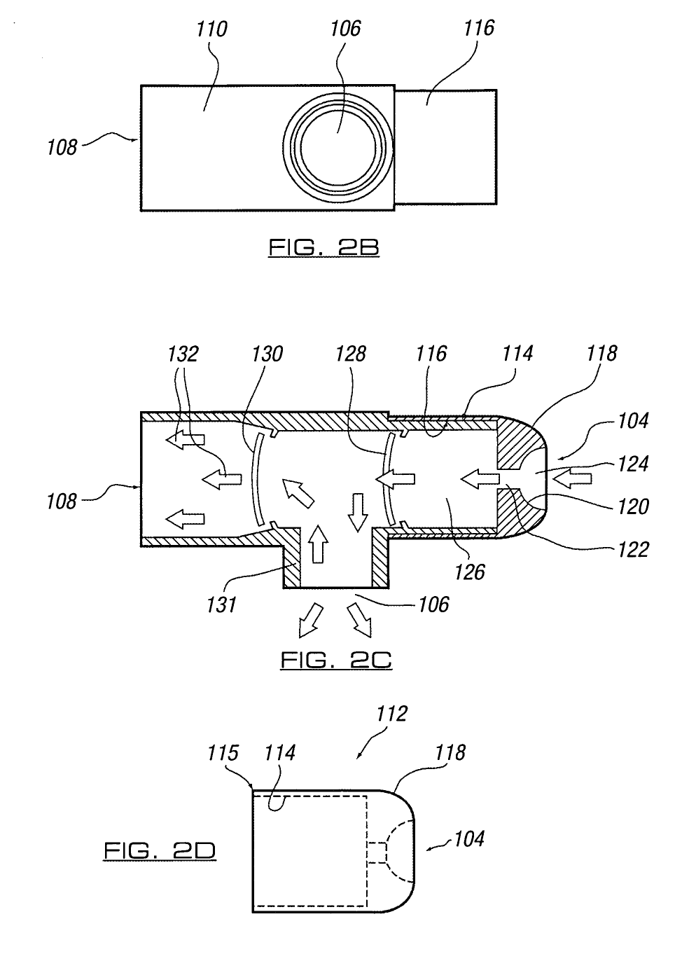

Referring to FIGS. 2a-2d, there is illustrated adaptor means in the form of a non-return tee piece adaptor 102.

The adaptor 102 includes a body portion 110 having an inlet port 104, first outlet means in the form of a first outlet port 108 and second outlet means in the form of an arm or diverter portion 131 having a second outlet port 106. In this embodiment, the body portion 110 is formed from a second part 110′ and a first part in the form of an inlet part 112. This inlet part 112 frictionally engages with second part 110′. More specifically, interior surface 114 of inlet part 112 at end 115 engages over exterior surface 116 of the second part 110′.

Inlet port 104 is defined at one end 118 of inlet part 112. End 118 is typically provided in a dome shaped formation and is configured to fit substantially flush against the o-ring or sealing means of an oxygen cylinder (not shown). Alternatively, end 118 can be configured to engage with a threaded portion of a DIN fitting of an oxygen cylinder.

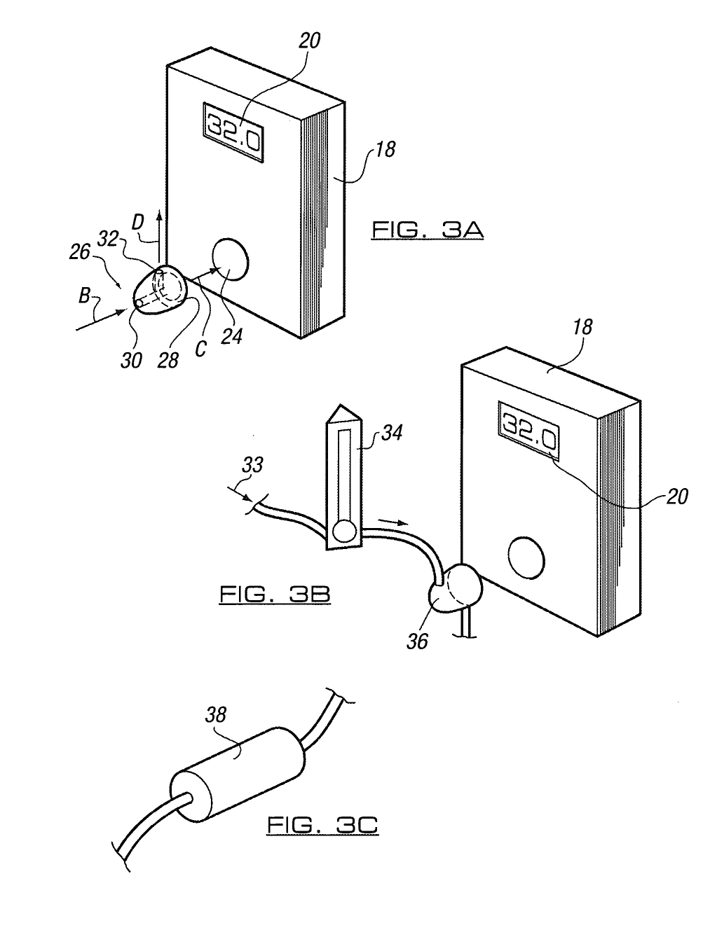

Conventional dome shaped ends suffer from two problems. Firstly, the venturi effect is possible as a result of poor sealing between the connection of the adaptor and the oxygen cylinder. Secondly, the adaptors still allow high pressure oxygen to flow directly onto the sensor membrane (numeral 24 in FIG. 3a) of the oxygen sensor fitted adjacent diverter outlet port 106 of adaptor 102 in use.

In accordance with the present invention, the inlet port 104 is provided substantially concave in shape as defined by interior walls 120 of the dome shaped end. A small aperture 122 is provided substantially centrally of the concave recess which joins the concave cavity/recess 124 with channel 126 passing through the adaptor 102. Thus, the inlet port 104 tapers inwardly from the outermost surface of inlet part 112 towards channel 126. The channel of inlet part 112 communicates with the channel of second part 110′.

The provision of this concave inlet cavity allows oxygen to build up therein and forces atmospheric or other gas out of the sampling gas stream. The size of aperture 122 is such so as to restrict the flow of oxygen through adaptor 102 but allow sufficient oxygen to enter the sensor provided at diverter outlet port 106 to enable a rapid measurement to be taken. The diameter of aperture 122 is substantially smaller than the largest diameter of the concave and/or conical cavity.

The device 102 has two one way valves 128, 130. These valves allow the oxygen to build up adjacent the sensor in use (i.e., between the two one way valves).

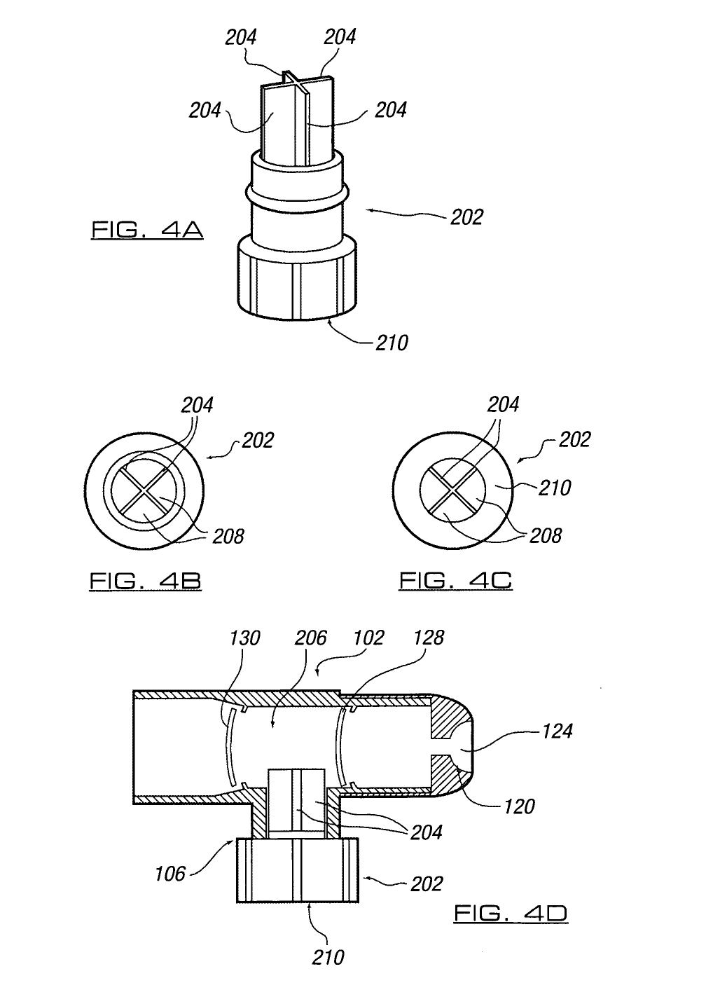

Referring to FIGS. 4a-4c, there is illustrated diverting means in the form of a flow divert valve 202 which can be used with adaptor 102 in one embodiment of the present invention. Flow divert valve 202 is located through outlet port 106 in diverter portion 131 in use, as shown in FIG. 4d. The valve 202 includes four flange members 204 which protrude at one end thereof into the gas flow passing through main channel 206 of adaptor 102 between the two one way valves 128, 130. The spaces 208 defined between the flanges and/or the flanges and the interior side walls of diverter portion 131 allow a small amount of gas to be diverted from the main flow passing between the inlet port 104 and the outlet port 108 to sensing apparatus located at end 210. This small sampling of gas prevents damage to the sensor membrane. The one way valves allow gas to flow one way through the adaptor without restriction across the flow divert valve located in diverter portion 131.

In use, a stream of oxygen is funnelled by the concave cavity 124 through aperture 122 and into channel 126. One way valve 128 restricts the flow of oxygen through aperture 122 into channel 126. The oxygen then flows to the sensor attached to the diverter outlet port 106. Excess high pressure oxygen travels directly through the oxygen sensor and into the atmosphere.

When the required measurement is reached (i.e., the measurement becomes stable), the flow of gas from the gas cylinder is switched off. The gas is trapped at 1 Bar in the sensor by the one way valves 128 and 130. The one way valves 128, 130 prevent atmospheric air from re-entering the sensor during the reading, thereby avoiding dilution of the oxygen with the air when the flow of gas from the gas cylinder has been switched off. In addition, the device allows the oxygen measurement to be taken whilst providing both flow rate and temperature stability to the gas being measured. Excess flow of oxygen is also vented via one way valve 130 as shown by arrows 132.

An advantage of the present invention is that the gas flows across the sensor and not directly onto the sensor face as is the case with existing dome shaped adaptors. This reduces the risk of high gas pressure in the device which can result in damage to the membrane of the sensor. The gas flow is for a short time only and so the temperature effects can be substantially reduced compared to prior art devices. In addition, the adaptor allows the gas reading to be taken at 1 Bar which is the only pressure at which the partial pressure of the gas equals the percentage oxygen readout.

The device of the present invention can be used by any level of diver or user for measuring the amount of oxygen/gas in a container/cylinder without requiring any pre-determined skill on the part of the user. The device is therefore considerably safer and more accurate than existing devices.

1. Adaptor means for use with gas measuring apparatus, said adaptor means in the form of a tee-piece adaptor having a body portion with a channel defined therethrough, said body portion including inlet means for allowing the flow of gas from gas supply means into the channel, first outlet means for allowing gas in the channel to exit the channel and second outlet means located between said inlet means and said first outlet means, said second outlet means communicating with said channel and allowing connection with gas sensing and/or measuring means, and wherein at least a part of said inlet means tapers inwardly towards said channel.

2. Adaptor means according to claim 1 wherein at least part of the wall of the inwardly tapering part of the inlet means which allows gas to flow into the channel is substantially concave or conical in shape.

3. Adaptor means according to claim 2 wherein at least one inlet aperture is defined in the concave shaped wall to allow gas to flow from the inlet means to the channel.

4. Adaptor means according to claim 1 wherein an arm portion is joined to said body portion and a channel defined in said arm portion communicates with the channel defined in said body portion, the second outlet means being provided on the arm portion.

5. Adaptor means according to claim 4 wherein the arm portion is provided substantially perpendicular to said body portion.

6. Adaptor means according to claim 4 wherein the second outlet means is defined at an end of said arm portion in communication with the channel defined in said arm portion.

7. Adaptor means according to claim 1 wherein diverting means are associated with the second outlet means for diverting the flow of gas as it flows from the inlet means to the first outlet means.

8. Adaptor means according to claim 7 wherein the diverting means includes one or more members which protrude into the channel defined in the body portion.

9. Adaptor means according to claim 8 wherein a plurality of members are provided and said members are arranged in a cruxiform arrangement.

10. Adaptor means according to claim 8 wherein one or more spaces are provided between said one or more members and/or the internal walls of the adaptor means to allow a sample of gas to be diverted from the channel in the body portion to gas sensing and/or measuring apparatus.

11. Adaptor means according to claim 7 wherein the diverting means includes sealing means.

12. Adaptor means according to claim 7 wherein the diverting means includes engagement means for allowing engagement of the diverting means to gas sensing and/or measuring apparatus.

13. Adaptor means according to claim 7 wherein the diverting means is integrally formed with the second outlet means and/or arm portion.

14. Adaptor means according to claim 7 wherein the diverting means are in the form of a flow divert valve.

15. Adaptor means according to claim 1 wherein the body portion includes at least two parts which are detachably attached together via attachment means.

16. Adaptor means according to claim 15 wherein a first part or inlet part of the body portion includes the inlet means and a second part of the body portion includes first and second outlet means.

17. Adaptor means according to claim 16 wherein the first part or inlet part can be retrofitted to a conventional tee-piece adaptor.

18. Adaptor means according to claim 15 wherein the attachment means includes any or any combination of adhesive, screws, clips, protrusion/recess engagement or friction fit.

19. Adaptor means according to claim 1 wherein an external surface of the body portion in which the inlet means are defined is substantially dome shaped.

20. Adaptor means according to claim 1 wherein the gas sensing and/or measuring apparatus has a measuring resolution of +/−1%.

21. Adaptor means according to claim 1 wherein one or more one way valves are provided therein.

22. Adaptor means according to claim 21 wherein the one or more one way valves are provided in or associated with the channel defined in the body portion.

23. Adaptor means according to claim 22 wherein two one way valves are provided, each valve provided in the channel of the body portion either side of the second outlet means.

24. Adaptor means according to claim 23 wherein gas is trapped between the valves at a pressure of one bar in use.

25. Adaptor means according to claim 3 wherein the diameter of the inlet aperture is substantially less than the largest diameter of the concave or conical shaped inlet means.

26. An inlet part for detachable attachment to adaptor means according to claim 15.

27. An inlet part for detachable attachment to adaptor means according to claim 16.

28. Gas measuring apparatus including adaptor means according to claim 1.
